(19) United States
(12) Patent Application Publication
(10) Pub. No.: US 2009/0083796 A1
(43) Pub. Date: Mar. 26, 2009

(54) INFORMATION RECOMMENDATION APPARATUS AND METHOD

(75) Inventors: Akira KARASUDANI, Kawasaki (JP); Takahiro MATSUDA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/236,197

(22) Filed: Sep. 23, 2008

(30) Foreign Application Priority Data
Sep. 25, 2007 (JP) 2007-247950

(51) Int. Cl. H04N 5/445

(52) U.S. Cl. 725/39

(57) ABSTRACT

An information recommendation apparatus and method displaying recommendation information based on a user's preference generated from a search index of information of operation(s) previously performed by the user including calculating a degree of similarity between recommendation information and operation information based on a search index for the recommendation information and a search index for the operation information, and outputting operation information having a degree of similarity that satisfies a specified condition as a recommendation reason for the recommendation information.

### CROSS-REFERENCE TO RELATED APPLICATIONS

This application is based upon and claims the benefit of priority of the prior Japanese Patent Application No. 2007-247950, filed on Sep. 25, 2007, the entire contents of which are incorporated herein by reference.

### BACKGROUND

1. Field

The present invention relates to an apparatus and method of displaying recommendation information based on a user's preference generated from a search index for information of operation(s) performed by the user.

2. Description of the Related Art

Technologies for searching programs by using a user's preference have been proposed for information apparatuses such as a personal computer on which a television or a video can be watched and a personal video recorder (PVR) which is a recording apparatus with a hard disk drive (HDD) or a digital video disk (DVD). For example, these information apparatuses may search Electric Program Guide (EPG) etc. for programs that match a user's preference by using the user's preference as the search condition.

An information apparatus may extract the user's preference after analyzing history of a user's operation. For example, the information apparatus may extract common information, such as keywords or broadcast time slots, from programs frequently recorded and replayed by the user. The information apparatus can display the searched programs based on the user's preference as recommended programs or automatically record such programs.

For searching programs using a user's preference, users generally want to know the reason why such programs are searched (reasons for recommendation). The user does not set conditions for such searching. Thus, the user does not understand why recommended programs are searched. Even if the user will view the recommended program for the first time, he or she can analogize the content of recommended programs by referring to the reason.

FIG. 1 is an example of a list of recorded or replayed programs used for analyzing a user's preference.

FIG. 2 is an example of major keywords included in the searched recommended programs. For example, in FIG. 2, “DONTO KUMORI” displayed as a recommended program shows keywords, “dorama, FINE, and OHSUGI”.

A metadata of a program may be acquired by a preference information extracting part, and preference information of the user is generated based on an attribute of the metadata to be stored in a server. The metadata to be recommended is retrieved by a recommendation information retrieval part, based on the preference information of the user, and a recommendation information exhibiting part exhibits to the user the attribute constituting the preference information as the reason of recommendation. The user books picture recording of the program based on the exhibited recommendation reason.

### SUMMARY

The disclosed information recommendation apparatus and method include displaying recommendation information based on a user's preference generated from search indices for operation information operated by the user in the past, includes; a degree of similarity calculation unit calculating a degree of similarity between the recommendation information and the operation information based on the a search index for the recommendation information and a search index for the operation information; and an output unit outputting the operation information that the degree of similarity calculated by the degree of similarity calculation unit satisfies a specified condition as recommendation reason for the recommendation information. The present invention is applicable for an HDD recorder or a personal computer.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an example of a list of recorded or replayed programs used for analyzing a user's preference;

FIG. 2 is an example of reasons for recommendation displayed by a typical information apparatus;

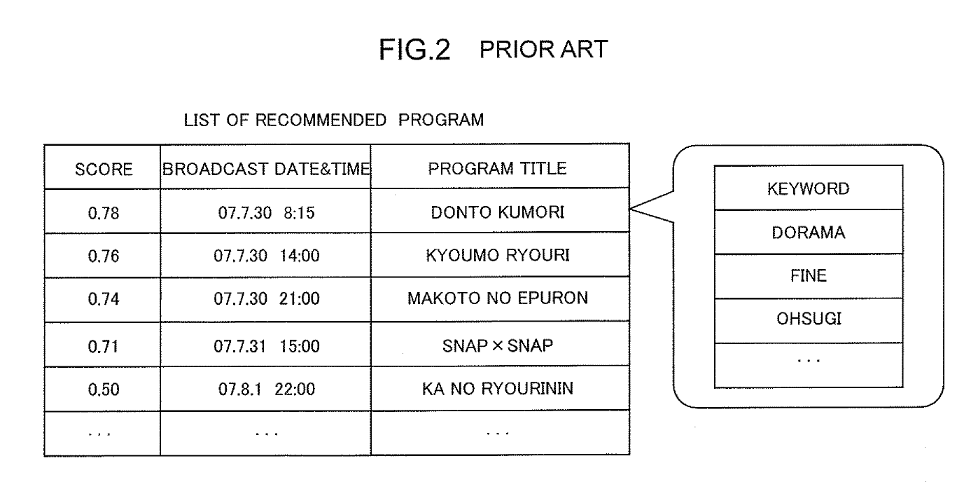

FIG. 3 is a functional block diagram illustrating a configuration of an information recommendation apparatus;

FIG. 4 is an example of EPG data stored in an EPG storage unit;

FIG. 5 is an example of operation history data stored in an operation history storage unit;

FIG. 6 is an example of a degree of importance management table stored in a degree of importance and interest storage unit;

FIG. 7 is an example of a degree of interest management table stored in a degree of importance and interest storage unit;

FIG. 8 is an example of search index data generated by a search index generation unit;

FIG. 9 is a figure illustrating extraction of a user's preference by a preference generation unit;

FIG. 10 is an example of a data structure of a user's preference;

FIG. 11 is an example of recommended program data;

FIG. 12 is a figure illustrating extraction of a recommended program by a recommended program search unit;

FIG. 13 is an example of recommendation reason data;

FIG. 14 is a figure illustrating extraction of a recommendation reason by a recommendation reason extraction unit;

FIG. 15 shows an example of keyword data;

FIG. 16 is a figure illustrating processes of removing overlapped information;

FIG. 17 is a figure illustrating an example of information displayed on a display;

FIG. 18 is a figure illustrating an example of information displayed on a display;

FIG. 19 is a third figure illustrating an example of information displayed on a display;

FIG. 20 is a illustrating processes of a preference change unit;

FIG. 21 illustrates a change of preference after a preference generation unit regenerates a user's preference;

FIG. 22 is a flowchart illustrating processes of an information recommendation apparatus;

FIG. 23 is a flowchart illustrating processes to extract recommendation reason;

FIG. 24 is a flowchart illustrating processes to extract keywords;

FIG. 25 is a flowchart illustrating processes to remove overlapped information;

FIG. 26 is a flowchart illustrating processes to change a user's preference;

FIG. 27 illustrates processes to extract recommendation reasons; and

FIG. 28 illustrates a hardware configuration of a computer comprising an information recommendation apparatus.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

In above discussed and other similar technologies, a relation between recommended program and reason(s) for recommendation is unclear. Therefore, the user can not easily adjust the user's preference (the user's preference analyzed by the information apparatus) used for searching recommended programs.

Now preferred embodiments of the information recommendation apparatus is explained in detail by referring to the accompanying drawings.

Firstly, an overview and characteristics of an information recommendation apparatus of an embodiment is explained.

For the convenience of explanation, the information recommendation apparatus of this embodiment is explained as an apparatus for searching programs such as television programs or videos, but not to limited to these. For example, the apparatus as discussed herein may be an information apparatus that searches or replays videos distributed on a network or searches or refers to text information such as news distributed on a network. The information recommendation apparatus and method displays recommended programs based on a user's preference generated from search indices for operation information related to operation(s) previously performed by the user. This apparatus searches for operation information which satisfies a specified condition of similarity between the search index for the recommended program for viewing (recommended program) and operation information and outputs the information as the reason(s) for recommendation.

Then, the user can clearly recognize a relation between the recommended program and the reason(s) for recommendation. Moreover, in an embodiment, the information recommendation apparatus accepts a user's evaluation of operation information output as reason(s) for recommendation, and thereby increases or decreases influence of the evaluated information on the user's preference.

Thus, the user can efficiently adjust or customize the preference used by the search for recommended programs.

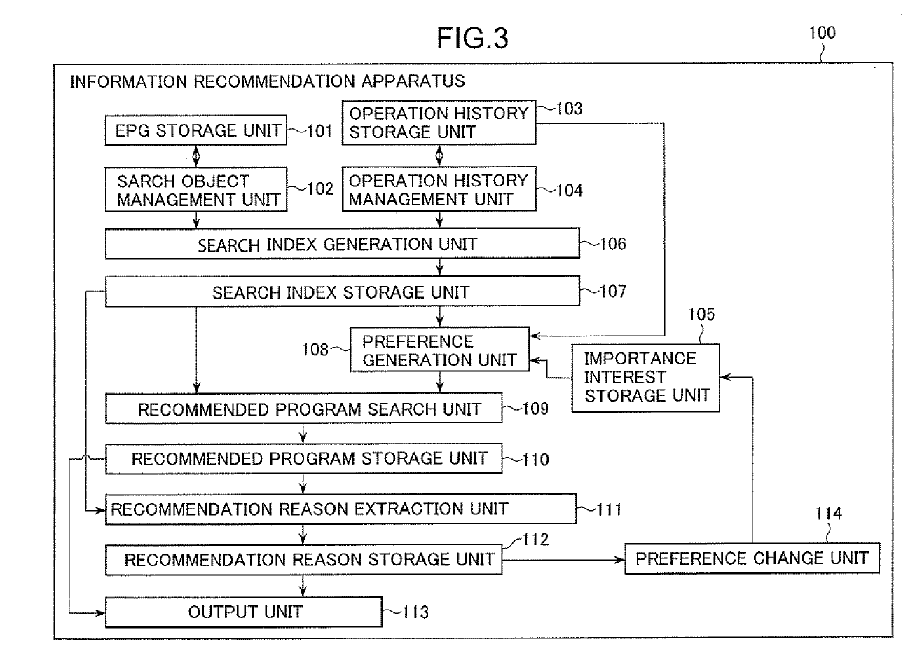

Now, a configuration of an information recommendation apparatus of an embodiment is explained. FIG. 3 is a functional block diagram illustrating a configuration of the information recommendation apparatus. As shown in FIG. 3, the information recommendation apparatus 100 comprises units 101 to 114.

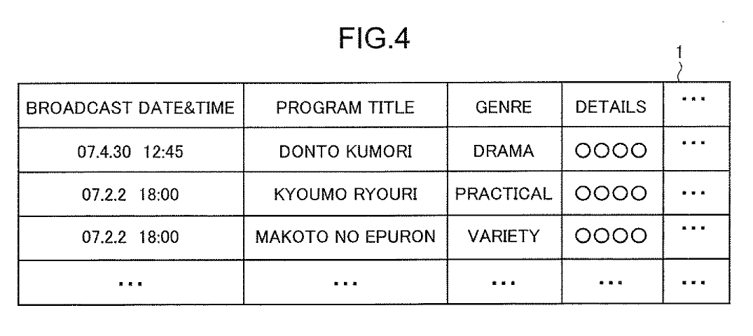

An EPG storage unit 101 stores various pieces of information on programs to be broadcasted from an Electric Program Guide (EPG). FIG. 4 shows an example of EPG data (1) stored in the EPG storage unit 101. As shown in FIG. 4, this EPG data includes data including broadcast date and time, a program title, a genre, and details of programs (including personalities and the content). Although specific EPG data is discussed, the present invention is not limited to any particular data and may include any information that identifies a broadcast or program.

A search object management unit 102 acquires EPG data stored in the EPG storage unit 101, and outputs the acquired EPG data to a search index generation unit 106. The unit 102 periodically acquires various pieces of information on programs to be broadcasted from the EPG and updates the EPG data stored in the EPG storage unit 101.

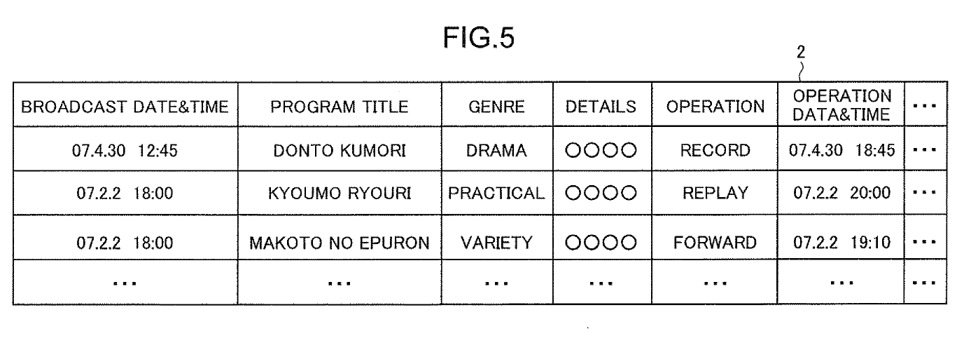

An operation history storage unit 103 stores various pieces of information of program(s) based on operation(s) by a user in the past and the content of operations (operation history data). FIG. 5 is an example of operation history data (2) stored in an operation history storage unit 103. As shown in FIG. 5, this operation history data includes but is not limited to the following information: broadcasted date and time, a program title, a genre, and details (personalities, and content, etc.) of programs, a user's operation(s) performed for the program(s) (record, replay, view, forward, rewind, and pause, etc.), and date and time when such operation(s) took place.

An operation history management unit 104 acquires operation history data stored in the operation history storage unit 103 and outputs the acquired operation history data to a search index generation unit 106. When the management unit 104 acquires additional operation history data from a monitor unit monitoring a user's operation (not shown), stores the acquired operation history data to the storage unit 103.

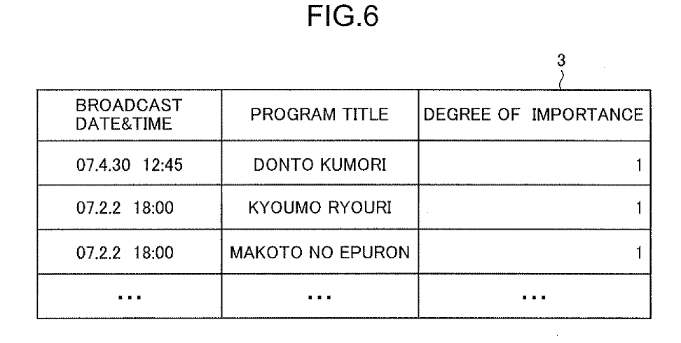

A degree of importance and interest storage unit 105 stores information on importance for each program (a degree of importance management table) and interest for each operation (a degree of interest management table). FIG. 6 is an example of a degree of importance management table (3) stored in a degree of importance and interest storage unit 105.

As shown in FIG. 6, the degree of importance management table includes broadcast date and time, title, and degree of importance for programs. The degree of importance indicates the value how much a user thinks a program is important. The higher the value, the more important the user thinks the program. Settings of each degree of importance can be changed arbitrary using an input device (not shown).

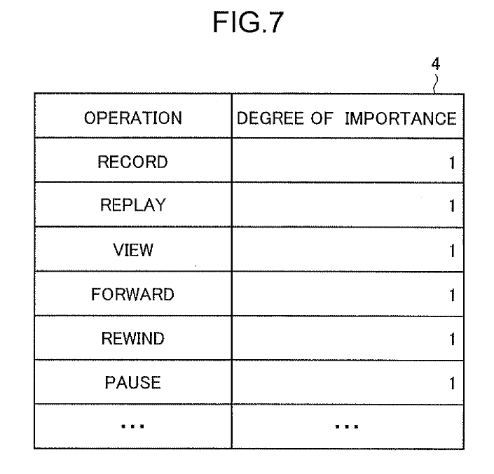

FIG. 7 is an example of a degree of interest management table (4) stored in a degree of an importance and interest storage unit 105. As shown in FIG. 7, the degree of interest table includes an operation type performed for program(s) and a degree of interest for a type of operation(s). The degree of interest indicates a value of how much the user thinks the operation type is important. The higher the value, the more important the user thinks the operation type. Settings of each degree of interest can be changed arbitrary using an input device.

The search index generation unit 106 acquires EPG data and operation history data and generates search indices for programs of the EPG data and programs of the operation history data. Now, an example of generating a search index using a vector space is explained.

When the search index generation unit 106 generates a search index for a program using a vector space, a basis of the vector space may be keywords included in the program title or the content of the program. For example, when a program title “DONTO KUMORI” includes keywords “KUMORI, HARE, OHSUGI . . . ” the basis of the search index for the program will be “KUMORI”, “HARE”, “OHSUGI” . . . .

The basis size is an amount of statistics for each keyword. For example, an amount of statistics is calculated by using Term Frequency (TF) or Document Frequency (DF). The TF indicates frequency of specific information, such as keywords, that appear in a program, whereas the DF indicates a number of programs among all of programs that includes a specific keyword. The expression for calculating amount of statistics (basis size) is as follows: TF/DF. The TF and DF shall be calculated beforehand by the search index generation unit 106 based on EPG data and operation history data.

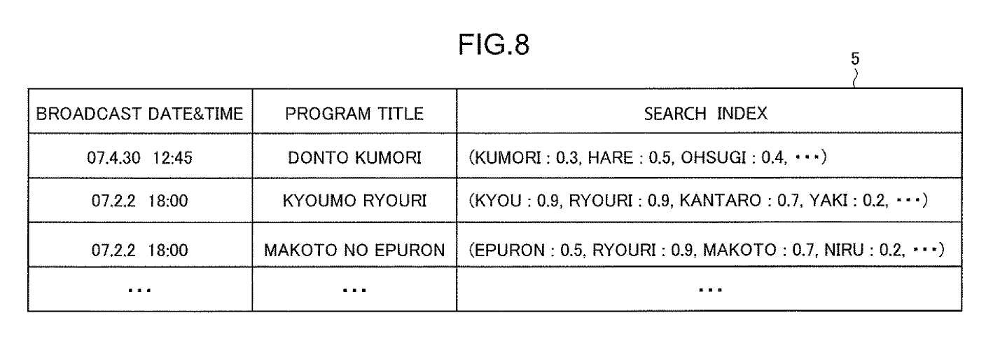

FIG. 8 is an example of search index data (5) generated by the search index generation unit 106. As shown in FIG. 8, the search index data includes broadcast date and time, the program title, the genre, and the search index. For example, the first line of FIG. 8 shows a search index (vector) of program title “DONTO KUMORI” with broadcast date and time “07.4.30, 12:45” is “KUMORI (basis size 0.3), HARE (basis size 0.5), and OHSUGI (basis size 0.4)”.

The search index generation unit 106 stores the generated search index data to a search index storage unit 107. The search index storage unit 107 is a unit for storing search index data.

A preference generation unit 108 extracts a user's preference from search indices for operation history data. Now, process(es) by a preference generation unit 108 are specifically explained. Firstly, the unit 108 compares operation history data (refer to FIG. 5) with search index data (refer to FIG. 8), and then extracts a search index for a program that the user operated in the past.

Subsequently, the unit 108 compares the broadcast date and time and title, degree of importance management table (refer to FIG. 6) and degree of interest management table of the program (refer to FIG. 7) corresponds to the program for the extracted search index, and then identifies the degree of importance and interest.

A preference generation unit 108 refers to operation history data, and if the user performs only a single operation (e.g., record only), the degree of interest for the operation shall be the degree of interest for the program of the search index. If multiple operations (e.g., record, view, and replay) are performed with respect to a program, the degree of interest for the program of search index is obtained by adding degree of interest for each of operations.

After identifying the degree of importance and interest for the search index, the preference generation unit 108 multiplies the identified degree of importance and interest by vector for the search index. For example, when importance “2”, interest “2”, a vector for the search index is “KUMORI (basis size 0.3), HARE (basis size 0.5), OHSUGI (basis size 0.4)”, the vector of search index obtained after the multiplication will be “KUMORI (basis size 1.2)”, HARE (basis size 2.0), and OHSUGI (basis size 1.6).

The preference generation unit 108 also identifies degrees of importance and interest for other extracted search indices as well, and multiplies a vector of search index by degrees of importance and interest. Then, the unit 108 extracts the vector obtained by adding vectors of each of search indices as the user's preference.

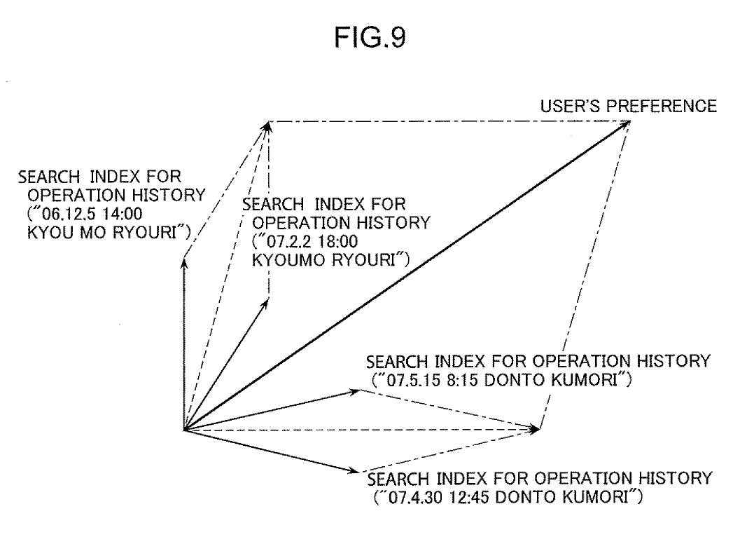

FIG. 9 is a figure for explaining extraction of a user's preference by the preference generation unit 108. As shown in FIG. 9, the user's preference is extracted by adding the following three indices: broadcast date and time “06.12.5 14:00”, titled “KYOU MO RYOURI”, broad cast date and time “07.5.15 8:15” titled “DONTO KUMORI”, and broadcast date and time “07.4.30 12:45” titled “DONTO KUMORI”.

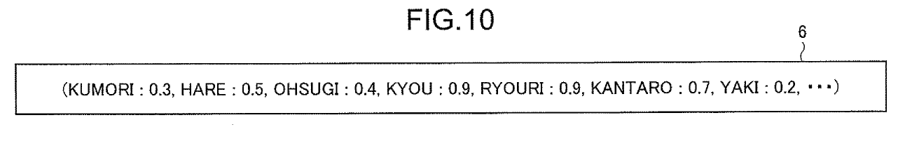

FIG. 10 is an example of a data structure of a user's preference (6). As shown in the example, the user's preference includes basis “KUMORI, HARE, OHSUGI, KYOU, RYOURI, KANTARO, YAKI . . . ” and the size of basis are “0.3, 0.5, 0.4, 0.9, 0.9, 0.7, 0.2 . . . ” respectively. The unit 108 outputs the extracted user's preference to a recommended program search unit 109.

The unit 109 extracts recommended program(s) based on search indices of each of programs corresponding to EPG data stored in a search index storage unit 107 and the user's preference (vector).

More specifically, the recommended program search unit 109 calculates inner products of vectors for search indices of each of the programs corresponds to EPG data and the user's preference respectively. Then, the unit 109 extracts programs with search indices that the calculated inner products between vectors is more than or equal to a specified value, and that the pair of search indices are the basis for the user's preference and then generates recommended program data.

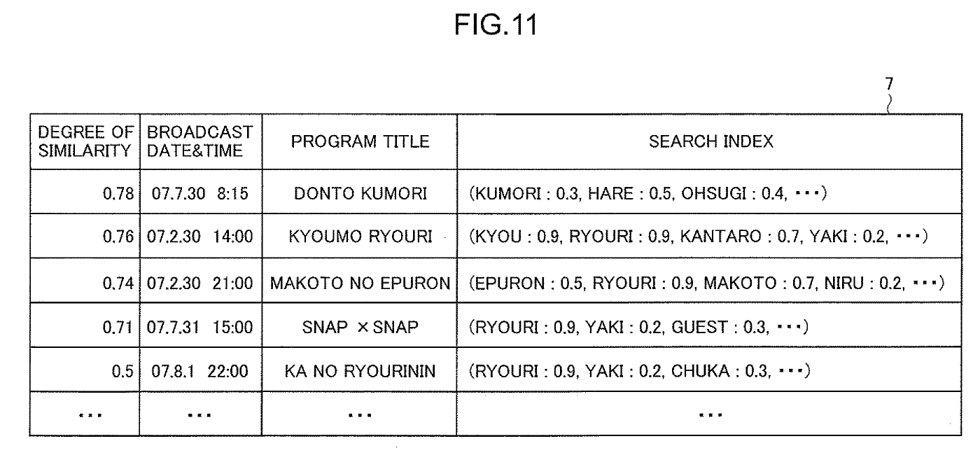

FIG. 11 is an example of recommended program data (7). As shown in FIG. 11, data of recommended program includes a degree of similarity that corresponds to a value of an inner product, a broadcast date and time, a program title, and a search index. The more a program matches the user's preference, the higher the similarity (inner product between vectors) becomes.

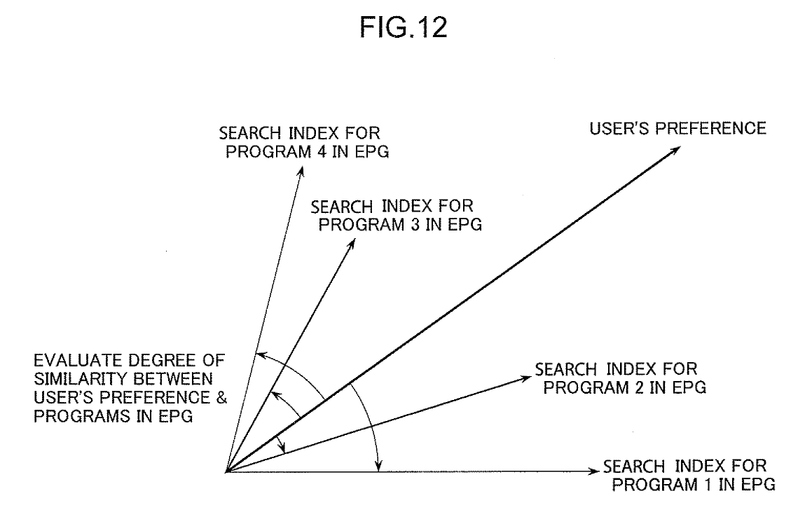

FIG. 12 is a figure for explaining extraction of a recommended program by a recommended program search unit 109. As shown in FIG. 12, the unit 109 calculates inner products between the user's preference and search indices of EPG programs 1 to 4 respectively. Then, the unit 109 extracts program(s) with search indices that the calculated inner product (degree of similarity) is more than or equal to a specified value as recommended programs. For example, the unit 109 extracts programs 2 and 3 as recommended programs when inner products of search index for EPG program 2 and the user's preference and that of EPG 3 and the user's preference are more than or equal to a specified value.

The recommended program search unit 109 stores data of a recommended program to a recommended program storage unit 110. The unit 110 is a unit for storing data of recommended program(s).

A recommendation reason extraction unit 111 is a unit for extracting recommendation reason(s), keyword(s) common to recommended program(s) and the reason(s), and removing overlapped information included in the recommendation reason. Now, process(es) of the recommendation reason extraction unit 111 is explained.

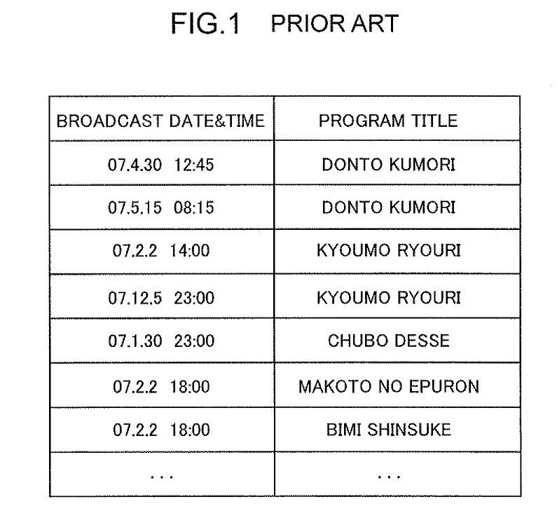

The recommendation reason extraction unit 111 acquires data of recommended programs (refer to FIG. 1) stored in a recommended program storage unit 110 and data of search indices (refer to FIG. 8), and then extracts search indices for recommended programs. Then the unit 111 calculates an inner product between vectors of a search index included in operation history data (refer to FIG. 5) and the search index for recommended program.

The unit 111 extracts programs with search indices that the calculated inner product between vectors is more than or equal to a specified value, and that the pair of search indices are the basis for the recommended program and then generates recommendation reason data.

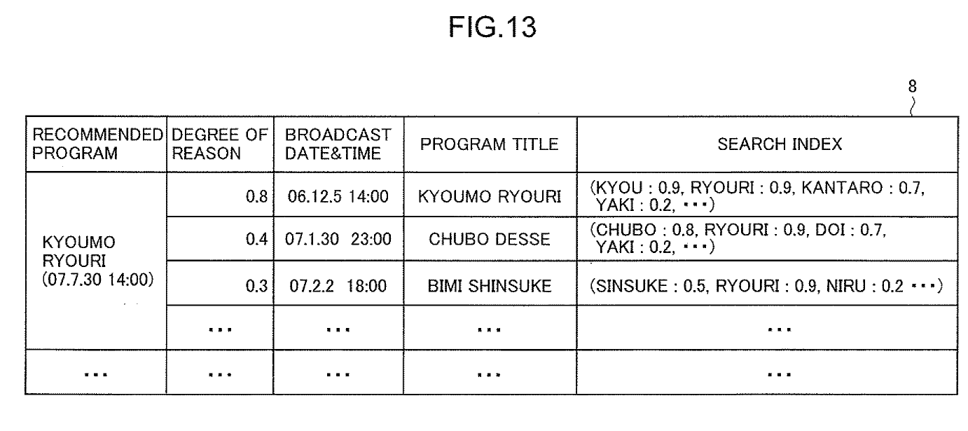

FIG. 13 is an example of recommendation reason data (8). As shown in FIG. 13, the recommendation reason data includes but is not limited to a recommended program, a degree of reason (calculation result of inner product between vectors of search index for recommended program), broadcast date and time, program title and search indices for programs of recommendation reason(s).

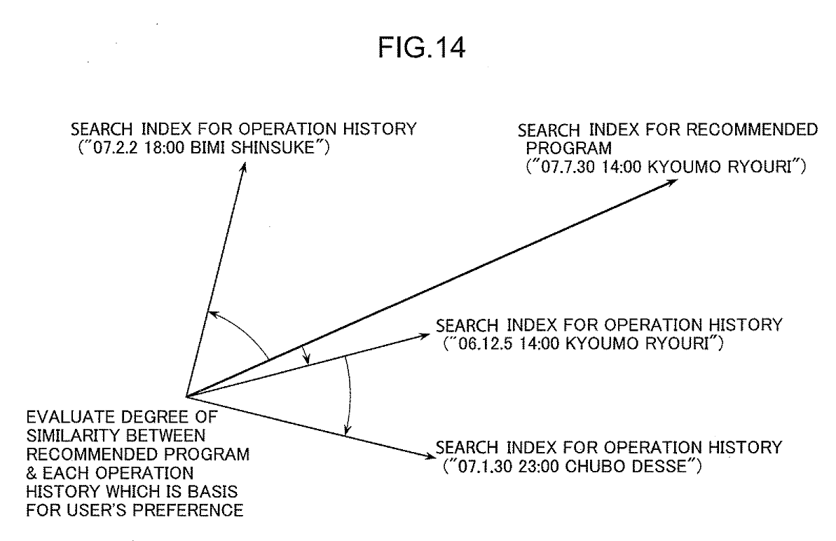

FIG. 14 is a figure for explaining extraction of recommendation reasons by a recommendation reason extraction unit 111. In the example of the FIG. 14, the unit 111 calculates inner products of vectors between a search index for a recommended program (broadcast date and time 07.7.30 14:00 titled “KYOU MO RYOURI”) and a search index for each operation history. For example, the unit 111 extracts the program of the operation history as recommendation reason for the recommended program if the inner product between a search index for the recommended program and a search index for the operation history (broadcast date and time 06.12.5 14:00 titled “KYOU MO RYOURI”) is more than or equal to a specified value. The unit 111 extracts recommendation reasons for each of recommended programs included in the recommended program data and stores the data as the recommendation reason data to a recommendation reason storage unit 112.

A recommendation reason extraction unit 111 calculates an inner product between vectors of a search index for a recommended program and that of recommendation reason program for the recommended programs. If the calculated inner product is more than or equal to a specified value (base), the unit 111 extracts as keywords.

Now, the processing is explained by showing specific examples.

Search index for recommended program (vector)

(KYOU: 0.9, RYOURI: 0.9, KANTARO: 0.7, YAKI: 0.2, SOBA: 0.2)

Search index for recommendation reason programs for the recommended programs (vector)

(KYOU: 0.9, RYOURI: 0.9, KANTARO: 0.7, Curry: 0.2, Rice: 0.2)

An inner product between above two search indices:

(KYOU: 0.9*0.9=0.81, RYOURI 0.9*0.9=0.81, KANTARO: 0.7*0.7=0.49)

For example, when a specified value is 0.5, the recommendation reason extraction unit 111 extracts “KYOU, RYOURI” as common keywords. The unit 111 stores the extracted keyword data in the recommendation reason storage unit.

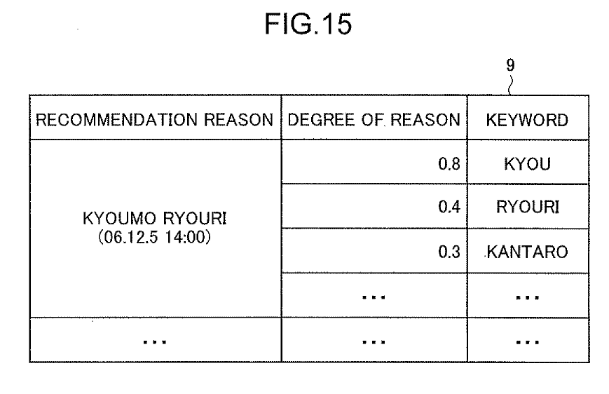

FIG. 15 shows an example of keyword data (9). As shown in FIG. 15, this keyword data includes a recommendation reason, a degree of reason (value obtained by multiplying keyword values as above), and keywords extracted from the recommendation reason.

When recommendation reason data (refer to FIG. 13) includes a plurality of information with the same content, the recommendation reason extraction unit 111 removes the overlapped information from the recommendation reason data. Any method/technology may be used for removing the recommendation reason information. For example, the unit 111 extracts search indices of recommendation reason programs included in the recommendation reason data, and calculates an inner product between vectors (search indices) of the recommendation reason programs. When the calculated inner product between the vectors is less than or equal to a specified value, then the unit 111 removes one of the recommendation reasons from the compared (i.e., the inner product is calculated) recommendation reasons.

Alternatively, the unit 111 compares program titles included in recommendation reason data. If the match rate of the titles is more than or equal to a specified rate, the unit 111 removes information on one of the compared recommendation reasons.

For example, “DONTO KUMORI 1” and “DONTO KUMORI 10” exist in the recommendation reasons, the following processes are performed.

The recommendation reason extraction unit 111 compares the above two titles, and finds that the words “DONTO KUMORI” are the same (the first 14 characters from the beginning are the same) and the rest differs (spaces are counted as well). At this time, if a condition is “12 characters from the beginning are the same” or “50% of character strings from the beginning are the same”, then the unit 111 assumes the two programs are the same, and removes one of them from the recommendation reasons. The program removed from the recommendation reasons can be judged from the date and time of operation or the date and time of broadcast. For example, the unit 111 may remove the one with the older broadcast time.

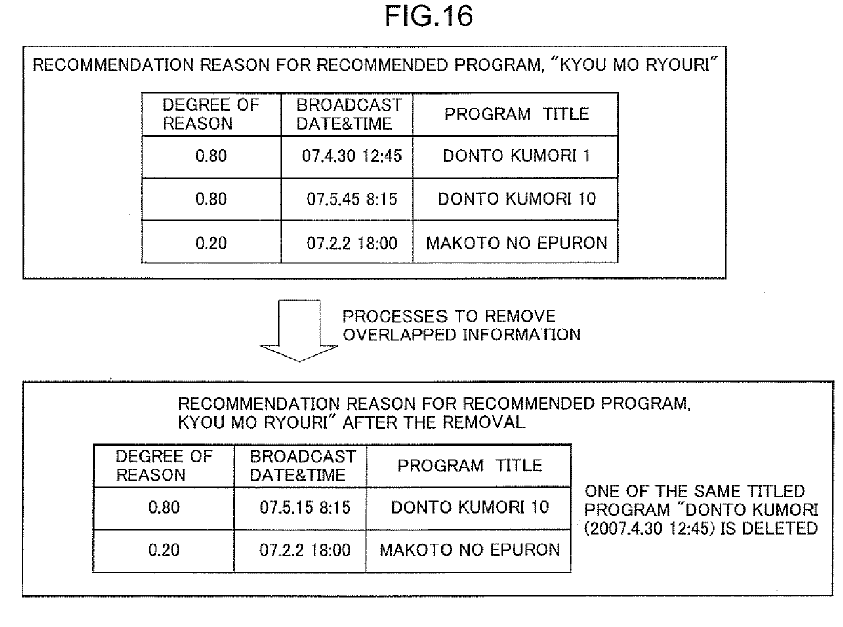

FIG. 16 is a figure for explaining processes of removing overlapped information. The recommendation reason extraction unit 111 deletes a line of “DONTO KUMORI 1” where programs with the overlapped title “DONTO KUMORI 1” and “DONTO KUMORI 10” exist (refer to table at the bottom of FIG. 16).

Now referring to FIG. 13, an output unit 113 outputs recommended programs, the recommendation reasons, and keywords to a display (not shown in FIGs) based on keyword data, data in a recommended program storage unit 110, and data in a recommendation reason storage unit 112.

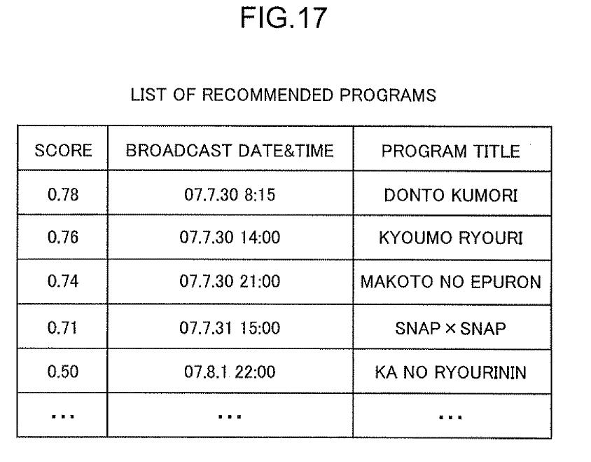

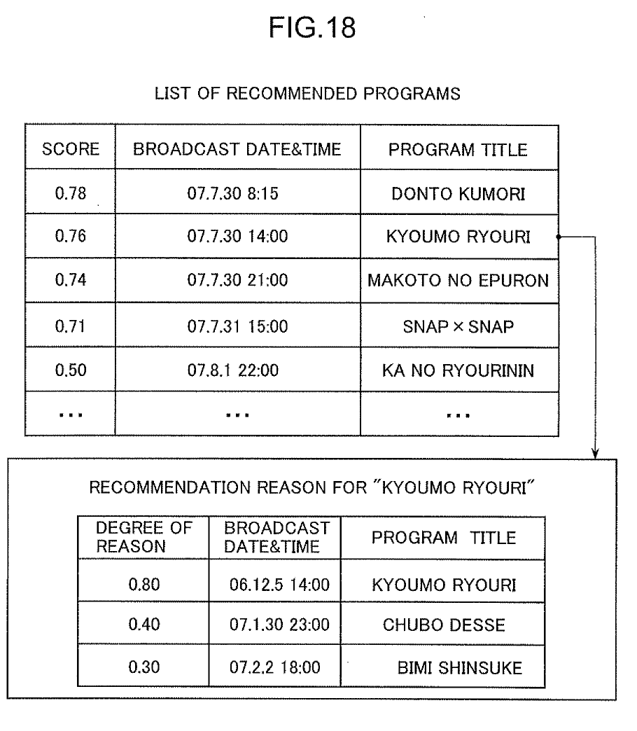

FIGS. 17 to 19 illustrate examples of information displayed on a screen. As shown in these FIGs, an output unit 113 displays a list of recommended programs based on recommended program data. A score in the list corresponds to a degree of similarity of recommended programs. When one of programs in the list is selected, the output unit 113 displays recommendation reasons corresponding to the selected program based on the recommendation reason data (refer to FIG. 18).

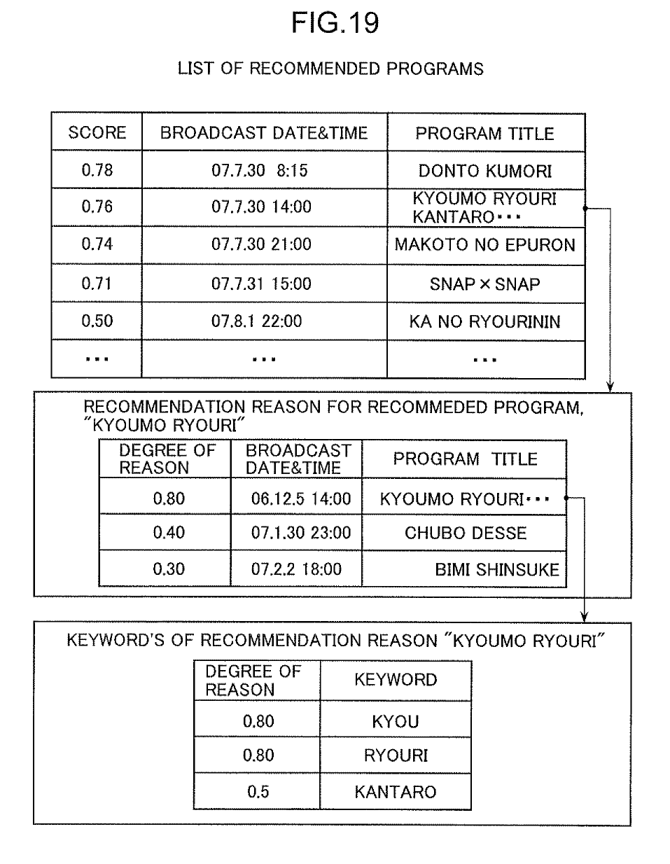

When one of programs in the displayed recommendation reasons is selected, the output unit 113 displays keyword(s) corresponding to the selected program based on the keyword data (refer to FIG. 19).

When a user's feedback to the recommended program is received after displaying the recommendation reason screen, a preference change unit 114 changes the importance in importance management table (refer to FIG. 6) stored in an importance and interest storage unit 105.

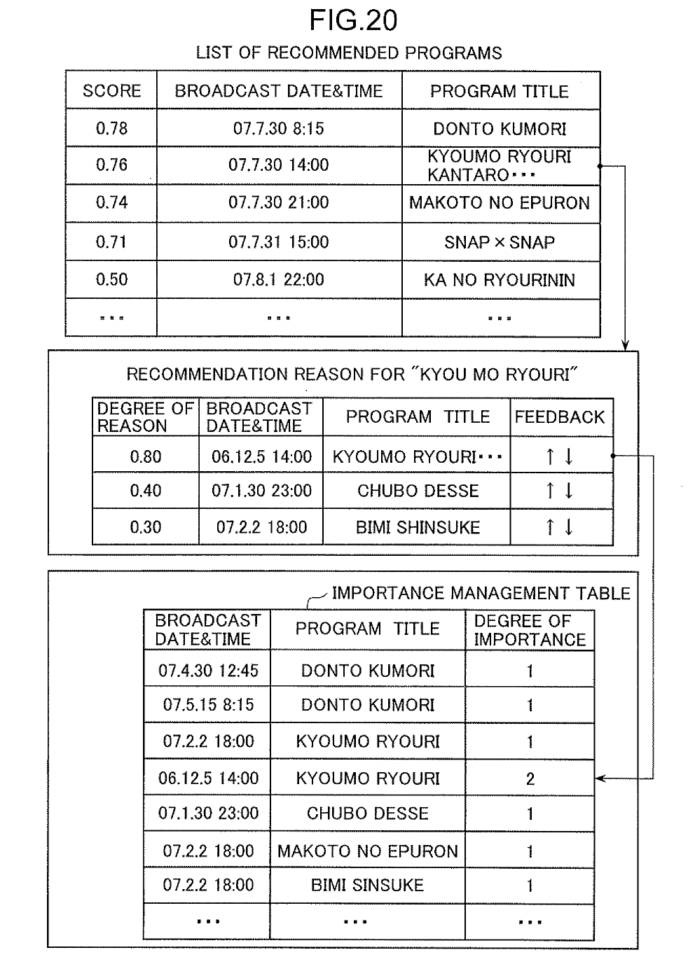

FIG. 20 is a figure for explaining process(es) of a preference change unit 114. As shown in FIG. 20, when the preference change unit 114 receives an instruction to increase a degree of importance of a program in the recommendation reason screen via an input device, the preference change unit 114 adds a specified value to the degree of importance of the program (FIG. 20 shows that “1” is added to the degree of importance for the program broadcast “06.12.5 14:00” and titled “KYOU MO RYOURI”).

Similarly, when the preference change unit 114 receives an instruction to decrease a degree of importance of a program in the recommendation reason screen via an input device, the preference change unit 114 subtracts a specified value from the degree of importance of the program.

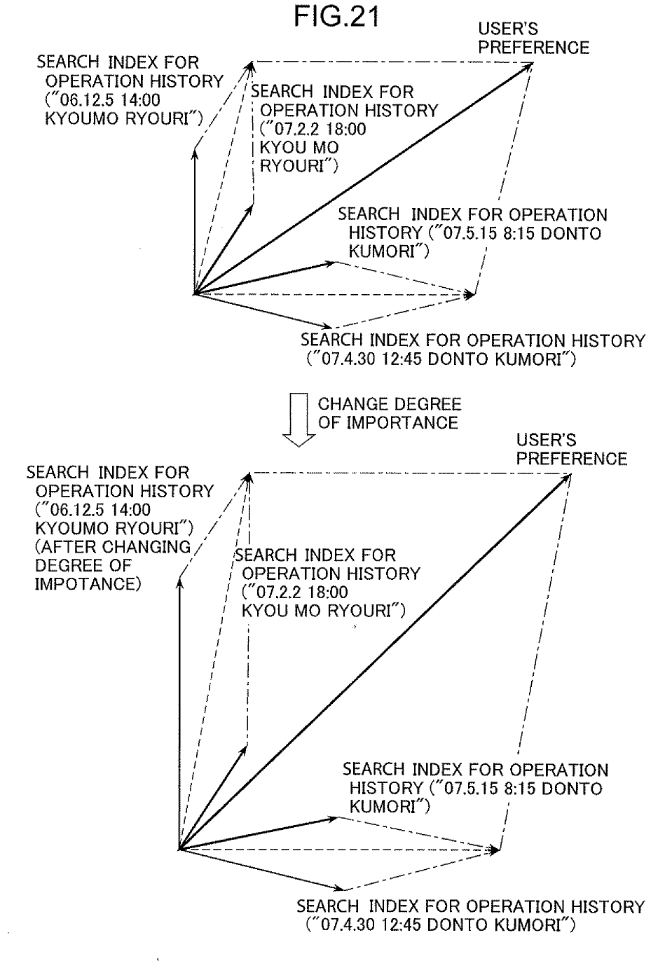

When the content of importance management table stored in a degree of importance and interest storage unit 105 is updated, the preference generation unit 108 regenerates the user's preference. FIG. 21 illustrates a change of preference after a preference generation unit 108 regenerates a user's preference. As shown in FIG. 21, changing the degree of importance changes the size of the search index (broadcast time “06.12.5 14:00” titled “KYOU MO RYOURI”), and as a result, the user's preference is changed as well.

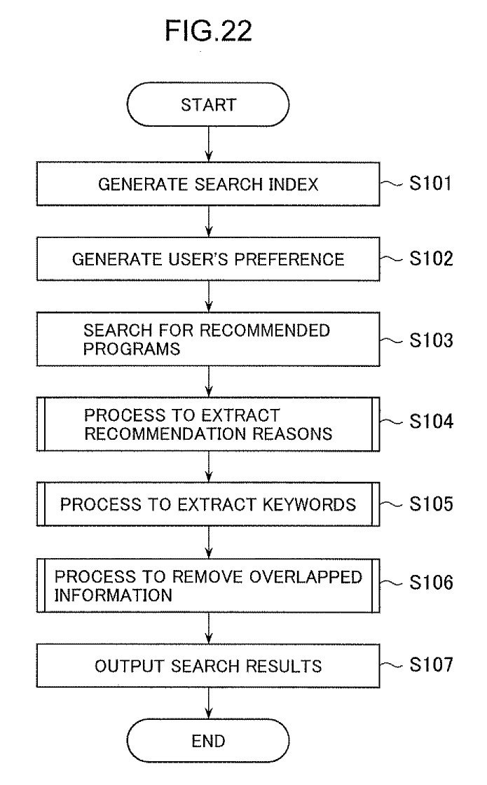

Now, process(es) of an information recommendation apparatus 100 of an embodiment are explained. FIG. 22 is a flowchart showing processing procedures of an information recommendation apparatus of an embodiment. In the information recommendation apparatus 100, a search index generation unit 106 acquires EPG data from a search object management unit 102 and operation history data from an operation history management unit 104, and then generates a search index (Operation S101).

Subsequently, a preference generation unit 108 acquires search index data stored in a search index storage unit 107 and generates the user's preference (Operation S102). Then, a recommended program search unit 109 searches recommended program(s) based on the user's preference and search index data (Operation S103).

A recommendation reason extraction unit 111 performs processes to extract recommendation reasons based on search indices for recommended programs and search indices for operation history (Operation S104). Then the unit 111 performs processes to extract keyword(s) based on search indices for recommended programs and search indices for recommendation reasons of the recommended programs (Operation S105).

Subsequently, the unit 111 performs removal processes based on the recommendation reasons (Operation S106). After that, an output unit 113 outputs the search result (recommended programs, recommendation reasons, and keywords) (Operation S107).

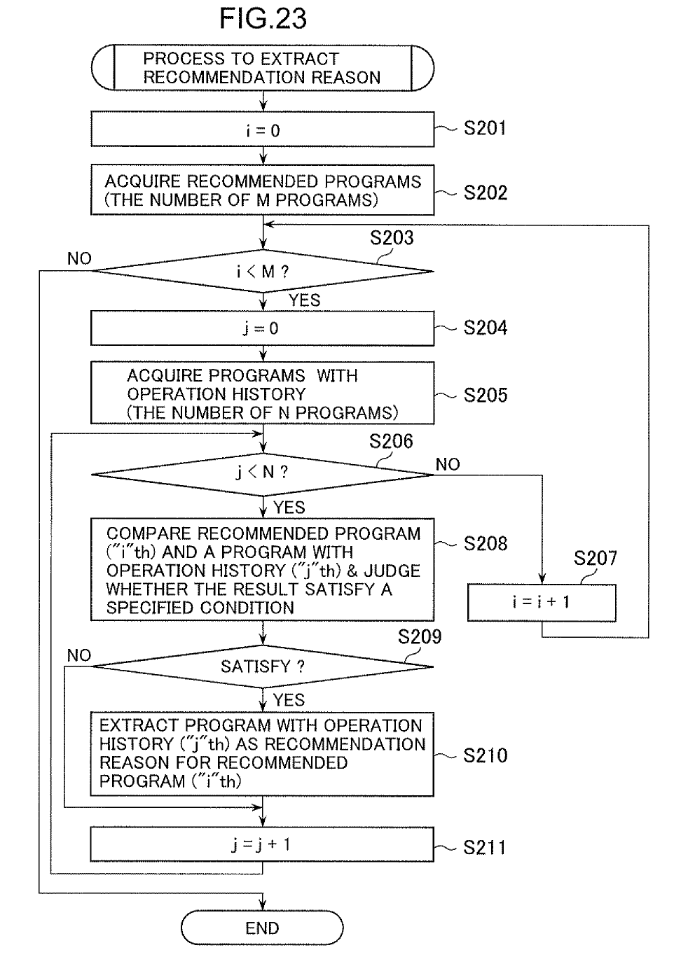

Next, process(e)s to extract recommendation reasons by a recommendation reason extraction unit 111 shown in FIG. 22 is explained. FIG. 23 is a flowchart showing processes to extract recommendation reasons. As shown in the FIG. 23, the unit 111 sets “i=0” (Operation S201). Then, the unit 111 acquires recommended programs (the number of M programs) (Operation S202). If a condition of “i<M” is not satisfied (Operation S203, No), the processes to extract recommendation reason completes. If a condition of “i<M” is satisfied (Operation S203, Yes), the unit 111 sets “j=0” (Operation S204). Then, the unit 111 acquires programs with operation history (the number of N programs) (Operation S205). If a condition of “j<N” is not satisfied (Operation S206, No), the unit 111 sets “i=i+1” (Operation S207). Now, the unit 111 proceeds to Operation S203.

If a condition of “j<N” is satisfied (Operation S206, Yes), the unit 111 compares a recommended program (“i” th) and a program with operation history (“j” th), and judges whether the comparison result satisfies a specified condition or not (whether an inner product between vectors is more than or equal to a specified value or not) (Operation S208).

If the specified condition is satisfied (Operation S209, Yes), the unit 111 extracts the program with operation history (“j”th) as a recommendation reason for the recommended program (“i”th) (Operation S210). Moreover, the unit 111 sets “j=j+1” (Operation S211). Then the unit 111 proceeds to Operation S206. If the specified condition is not satisfied (Operation S209, No), the unit 111 proceeds to Operation S211.

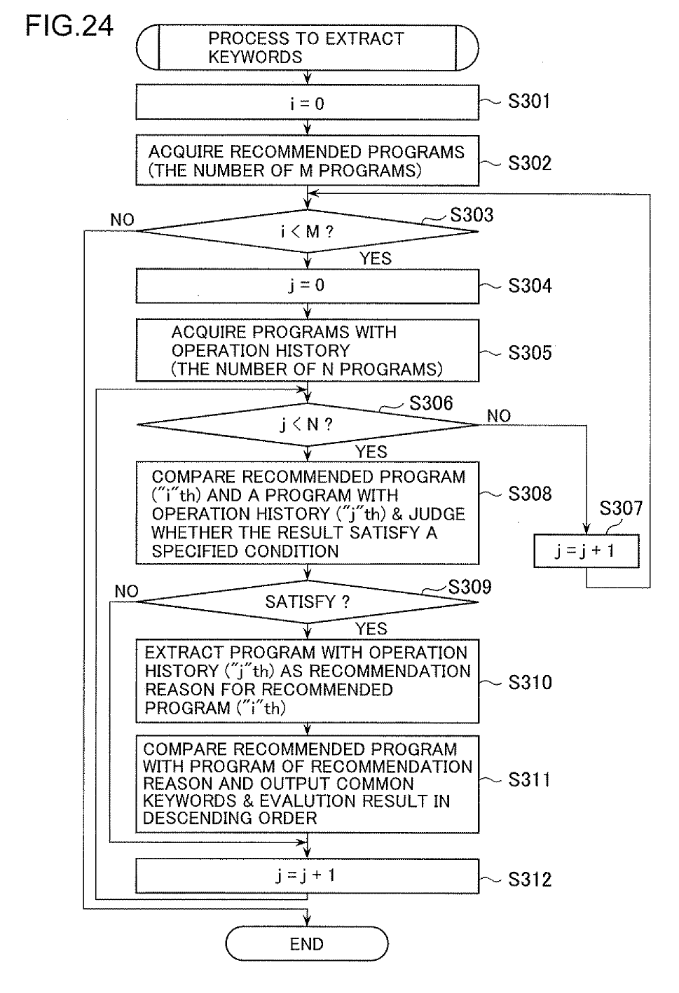

Next, processes to extract keywords by a recommendation reason extraction unit 111 shown in FIG. 22 is explained. FIG. 24 is a flowchart showing processes to extract keywords. As shown in the FIG. 24, the unit 111 sets “i=0” (Operation S301). Then, the unit 111 acquires recommended programs (the number of M programs) (Operation S302). If a condition of “i<M” is not satisfied (Operation S303, No), the processes to extract keywords complete.

If a condition of “i<M” is satisfied (Operation S303, Yes), the unit 111 sets “j=0” (Operation S304). Then, the unit 111 acquires programs with operation history (the number of N programs) (Operation S305). If a condition of “j<N” is not satisfied (Operation S306, No), the unit 111 sets “i=i+1” (Operation S307), and proceeds to Operation S303.

If a condition of “j<N” is satisfied (Operation S306, Yes), the unit 111 compares the recommended program (“i” th) with the program with operation history (“j” th), and judges whether the result satisfies the specified condition or not (an inner product between vectors is more than or equal to a specified value) (Operation S308).

If the specified condition is satisfied (Operation S309, Yes), the unit 111 extracts a program with operation history (“j”th) as a recommendation reason for the recommended program (“i”th) (Operation S310). The unit 111 compares the recommended program with the program of recommendation reason, and outputs common keywords and the evaluation result (a degree of reason) in descending order of the degree (Operation S311). Moreover, the unit 111 sets “j=j+1” (Operation S312) and proceeds to Operation S306. If the specified condition is not satisfied (Operation S309, No), the unit 111 proceeds to Operation S312.

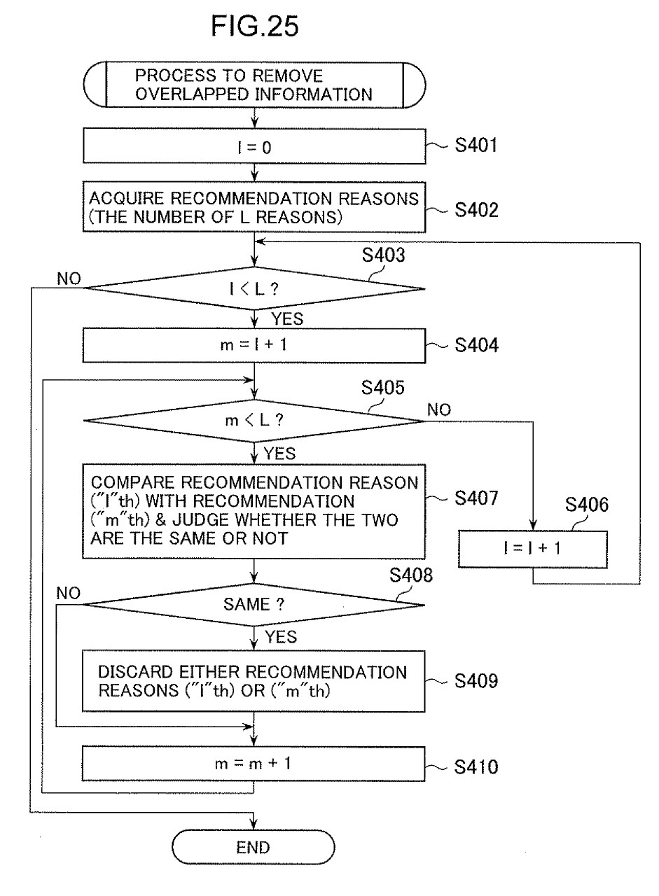

Next, processes to remove overlapped information of a recommendation reason extraction unit 111 shown in FIG. 22 is explained. FIG. 25 is a flowchart showing processes to remove overlapped information. As shown in the FIG. 25, the unit 111 sets “l=0” (Operation S401). Then, the unit 111 acquires recommendation reasons (the number of L reasons) (Operation S402). If a condition of “l<L” is not satisfied (Operation S403, No), the unit 111 completes the processes to remove overlapped information.

If a condition of “l<L” is satisfied (Operation S403, Yes), the unit 111 sets “m=l+1” (Operation S404). If a condition of “m<L” is not satisfied (Operation S405, No), the unit 111 sets “l=l+1” (Operation S406) and proceeds to Operation S403.

If a condition of “m<L” is satisfied (Operation S405, Yes), the unit 111 compares a recommendation reason (“l”th) with a recommendation reason (“m”th) and judges whether the two are the same or not (Operation S407). If the two are the same (Operation S408, Yes), the unit 111 discards either the recommendation reasons (“l”th) or (“m”th) (Operation S409).

The unit 111 sets “m=m+1” (Operation S410) and proceeds to Operation S405. Then, the unit 111 compares a recommendation reason (“l”th) with a recommendation reason (“m”th). If the two are different (Operation S408, No), the unit 111 proceeds to Operation S410.

As explained above, the recommendation reason extraction unit 111 calculates a degree of similarity using recommended programs (search indices for recommended programs) and programs with operation history (search indices for programs with operation history), and extracts programs which satisfy the specified condition as programs of recommendation reasons. Thus, the unit 111 can clearly notify or indicate a degree of influence that programs of recommendation reasons have for the recommended programs.

The unit 111 compares the recommended programs (search indices for recommended programs) with programs of recommendation reasons (search indices for programs of recommendation reasons), and extracts keywords common to the both with the degree of reason exceeds a specified value. Thus the unit 111 can notify by outputting keywords that influence recommendation reasons and the degree of influence that the keywords have for the programs of recommendation reason to a user.

The unit 111 can prevent the same recommendation reasons from being displayed, since the unit 111 removes the overlapped information so that only single recommendation reason remains. Thus, the unit 111 can display various recommendation reasons where a limited number of recommendation reasons can be displayed.

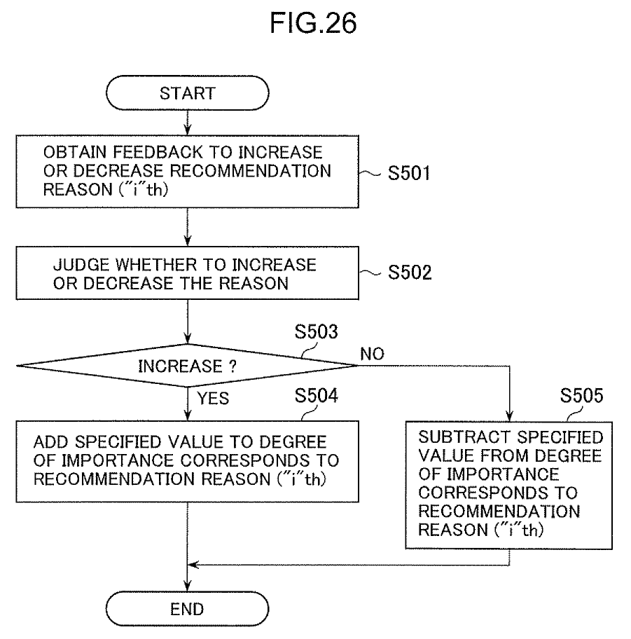

Next, processes to change a user's preference by the preference change unit 114 are explained. FIG. 26 is a flowchart showing processes to change a user's preference. As shown in FIG. 26, the unit 114 obtains feedback to increase or decrease a recommendation reason (“i”th) (Operation S501), and judges whether to increase or decrease the reason (Operation S502).

When the recommendation reason is to be increased (Operation S503, Yes), the unit 114 adds a specified value to the degree of importance corresponding to the recommendation reason (“i”th) (Operation S504). On the other hand, when the recommendation reason is to be decreased (Operation S503, No), the unit 114 subtracts a specified value from the degree of importance corresponding to the recommendation reason (“i”th) (Operation S505).

As explained above, the unit 114 obtains feedback of either an increase or a decrease of a recommendation reason, and adjusts the importance corresponding to the recommendation reason depending on the obtained results. Thus, the unit 114 can adjust the user's preference depending on the preference, and acquires recommended programs that are better suited to the user's preference.

As mentioned above, the search index generation unit 106 of the information recommendation apparatus 100 of an embodiment generates a search index for each program. The recommendation reason extraction unit 111 calculates the degree of similarity between recommended programs and operation information using search indices for recommended programs and search indices for operation information, and outputs operation information that the calculated similarity satisfies the specified condition as recommendation reasons for the recommended programs.

Accordingly, relation between recommended programs and the recommendation reason can be clarified.

A vector space is used as a search method in an embodiment, however the disclosed apparatus and method is not limited to this, instead a Boolean search or a probabilistic search may be used as well.

An embodiment of this disclosure has been described above; the present disclosure may be achieved by various embodiments as well. Accordingly, other embodiments of this disclosure are explained hereunder.

For instance, in the above described embodiment, an example of extracting recommendation reasons is explained in which the recommendation reason extraction unit 111 extracts recommendation reason data by comparing search indices for recommended program data and search indices for all operation history data. However, the method is not limited to this and the unit 111 can speed up the time to process extraction by setting a specified search condition beforehand and thereby narrowing down the number of operation history data for comparison. The extraction may be customized based on a setting or configuration, for example, by narrowing down keyword(s), using operation date and time, and/or operation pattern.

The unit 111 extracts keywords included in recommended program data and compares the extracted keywords with operation history data. Then, the unit 111 can obtain only search indices of operation history data which includes a specified number (e.g., more than or equal to 1) of keywords of recommended program data as search indices to be compared for extracting recommendation reasons.

The unit 111 can obtain search indices with operation date and time within a specified period as search indices to be compared for extracting recommendation reasons. A user can freely specify the period.

The unit 111 can obtain search indices with a specified operation pattern (e.g., operation history indicates replay is performed after recording a program) as a search indices to be compared for extracting recommendation reasons. A user can freely specify the operation pattern.

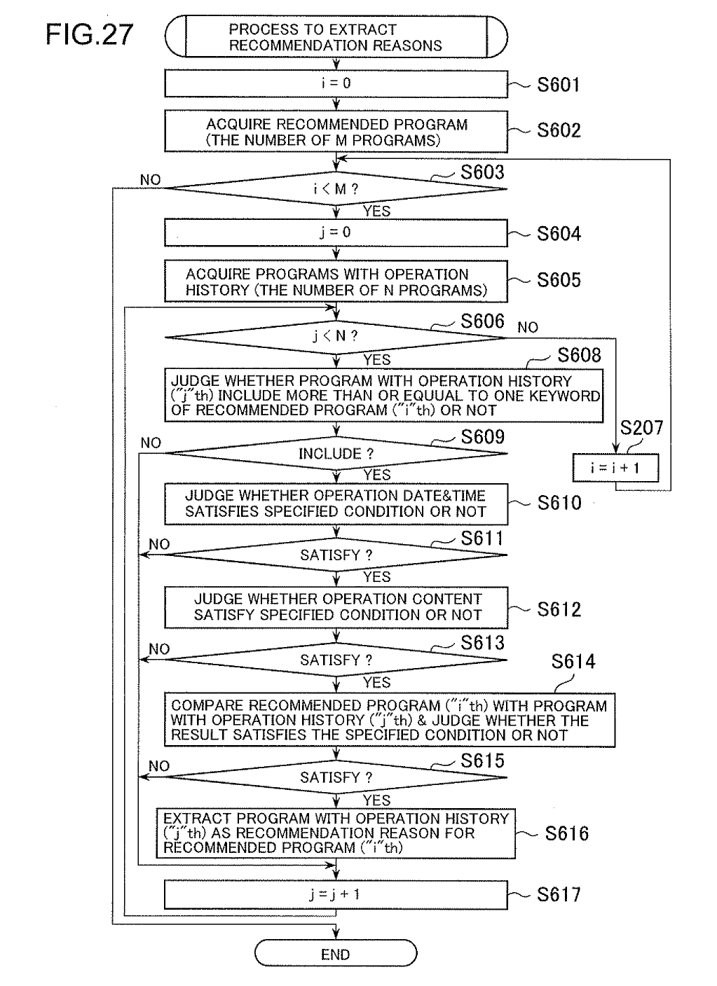

Now, process(es) of the unit 111 to narrow down by keywords, operation date and time, and operation patterns are explained. FIG. 27 shows processes to extract recommendation reasons. As shown in FIG. 27, the unit 111 sets “i=0” (Operation S601). Then, the unit 111 acquires recommended programs (the number of M programs) (Operation S602). If a condition of “i<M” is not satisfied (Operation S603, No), the unit 111 completes the processes to extract keywords.

If a condition of “i<M” is satisfied (Operation S603, Yes), the unit 111 sets “j=0” (Operation S604). Then, the unit 111 acquires programs with operation history (the number of N programs) (Operation S605). If a condition of “j<N” is not satisfied (Operation S606, No), the unit 111 sets “i=i+1” (Operation S607), and proceeds to Operation S603.

If a condition of “j<N” is satisfied (Operation S606, Yes), the unit 111 judges whether a program with operation history (“j”th) include more than or equal to one keyword of the recommended program (“i” th) or not (Operation S608).

When a program with operation history (“j” th) does not include more than or equal to one keyword of a recommended program (“i”th) (Operation S609, No), the unit 111 proceeds to Operation S617. When the program with operation history (“j” th) includes more than or equal to one keyword of the recommended program (“i”th) (Operation S609, Yes), the unit 111 judges whether the operation date and time satisfy the specified condition or not (Operation S610).

If the operation date and time do not satisfy the specified condition (Operation S611, No), the unit 111 proceeds to operation S617. On the other hand, if the operation date and time satisfies the specified condition (Operation S611, Yes), the unit 111 judges whether the operation content satisfies the specified condition or not (Operation S612). If the specified condition is not satisfied (Operation S613, No), the unit 111 proceeds to operation S617. If the specified condition is satisfied (Operation S613, Yes), the unit 111 compares a recommended program (“i” th) with a program with operation history (“j” th), and judges whether the result satisfies the specified condition or not (an inner product between vectors is more than or equal to a specified value) (Operation S614).

If the specified condition is not satisfied (Operation S615, No), the unit 111 proceeds to Operation S617. If the specified condition is satisfied (Operation S615, Yes), the unit 111 extracts a program with operation history (“j”th) as a recommendation reason for the recommended program (“i”th) (Operation S616). Moreover, the unit 111 sets “j=j+1” (Operation S617) and proceeds to Operation S606.

In above described embodiment, a preference change unit 114 changes an importance management table stored in a degree of importance and interest storage unit 105, when a user's feedback to a program of recommendation reasons is received after displaying recommendation reason screen.

When one of overlapped programs is deleted and an instruction to increase importance of the other program is received, the unit 114 adds a specified value to the degree of importance for both of the programs.

As shown in FIG. 16, for example, when “DONTO KUMORI 1” is deleted, and an instruction to increase importance of “DONTO KUMORI 10” is received, the unit 114 adds a specified value to the degree of importance for both of “DONTO KUMORI 1” and “DONTO KUMORI 10”.

Similarly, when one of overlapped programs is deleted and an instruction to decrease importance of the other program is received, the unit 114 subtracts a specified value from the degree of importance for both of the programs.

As shown in FIG. 16, for example, when “DONTO KUMORI 1” is deleted, and an instruction to decrease importance of “DONTO KUMORI 10” is received, the unit 114 subtracts a specified value from the degree of importance for both of “DONTO KUMORI 1” and “DONTO KUMORI 10”.

The unit 114 shall retain a table to associate overlapped programs of recommendation reasons with deleted programs of recommendation reasons.

In an example shown in FIG. 16, the overlapped programs of recommendation reasons (“DONTO KUMORI 1” and “DONTO KUMORI 10”) and deleted program of recommendation reasons (“DONTO KUMORI 10”) are made to associate each other and stored in a correspondence table.

In an example shown in the embodiment, a preference change unit 114 adjusts a degree of importance for programs of recommendation reasons upon receiving evaluation for programs of recommendation reasons; however the method is not limited to this. The unit 114 may adjust the degree of importance of the programs of the recommendation reasons upon receiving the evaluation for the corresponding recommended program.

For example, in FIG. 19, the unit 114 may add a specified value to the degree of importance of “KYOU MO RYOURI, CHUBO DESSE and BIMI SHINSUKE” which are programs of the recommendation reasons, when an instruction to increase the degree of importance for the recommended program “KYOU MO RYOURI” is received.

Similarly, the unit 114 may decrease a specified value from the degree of importance of “KYOU MO RYOURI, CHUBO DESSE, and BIMI SHINSUKE” which are programs of recommendation reasons, when an instruction to decrease the degree of importance of the recommended program “KYOU MO RYOURI” is received.

Furthermore, from among the processes described in the present embodiments, a part of processes or all processes that are described to have been performed automatically can be performed manually, or a part of processes or all processes that are described to have been performed manually can be performed automatically by a known method. Apart from this, processing procedures, controlling procedures, concrete names, and information that include various data and parameters shown in this document and diagrams can be changed voluntarily except when mentioned specially.

Components of the information recommendation apparatus 100 shown in FIG. 3 are functional conception, and it is not necessarily required to be configured physically as shown in the drawing. In other words, a concrete form of distribution and integration of the unit is not restricted to that shown in the diagram, and a part of it or the whole of it can be configured by distributing and integrating functionally or physically in voluntary units according to load and use conditions. Furthermore, a voluntary part of each processing function or the whole of each processing function that is performed by each of units can be realized by a CPU and a computer program that is analyzed and run by the CPU, or can be realized as hardware by a wired logic.

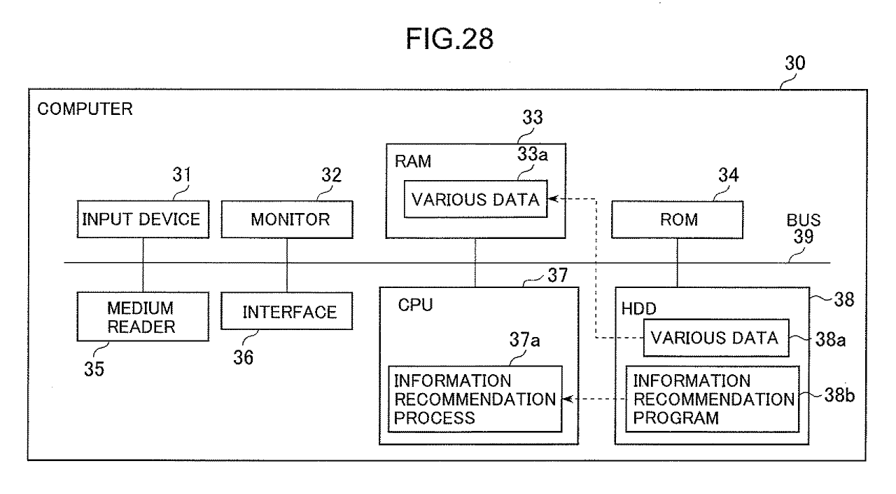

FIG. 28 shows a hardware configuration of a computer comprising an information recommendation apparatus of an embodiment. As shown in the FIG. 28, a computer 30 is configured by connecting an interface 36, a central processing unit (CPU) 37, and a hard disk drive (HDD) 38 via a bus 39. The interface 36 transmits and receives data among an input device 31 that accepts a user's instruction, a monitor 32, a random access memory (RAM) 33, a read only memory (ROM) 34, and a medium reader 35, and other devices.

The HDD 38 stores an information recommendation program 38b which provides the same functions as those of above information recommendation apparatus 100. The CPU 37 reads and executes the information recommendation program 38b, and thereby the information recommendation process 37a is activated. The information recommendation process corresponds to the search object management unit 102, the operation history management unit 104, the search index generation unit 106, the preference generation unit 108, the recommended program search unit 109, the recommendation reason extraction unit 111, the output unit 113, and the preference change unit 114 shown in FIG. 3.

The HDD 38 stores various data 38a used by information processing processes. The various data 38a corresponds to data stored in an EPG storage unit 101, an operation history storage unit 103, a search index storage unit 107, an importance and interest storage unit 105, a recommended program storage unit 110, and a recommendation reason storage unit 112, etc.

The CPU 37 reads various data 38a stored in the HDD 38, and stores the data to the RAM 33, and extracts programs of recommendation reasons and keywords using the stored various data 33a.

The information recommendation program 38b shown in FIG. 28 is not necessarily stored in the HDD 38 from the beginning. For instance, the program may be stored in “a portable physical device”, “a fixed physical device” and “other computer (or server)” and read and executed by a computer. The “portable physical device” includes a flexible disk (FD), a compact disk read-only-memory (CD-ROM), a digital video disk (DVD), a magnet optical disk (MO) and an integrated circuit (IC) card. The fixed physical device includes a hard disk drive (HDD) provided within or outside of a computer. Other computer (or server) is connected to a computer via a public network, Internet, LAN or WAN.

According to an embodiment, a search index for each program is generated, and a degree of similarity between recommended information (recommended program) and operation information is calculated by using a search index for a recommended program and a search index for operation information, and operation information with calculated similarity satisfying the specified condition are output as programs of recommendation reasons. By using the calculated similarity, how much influence the recommendation reason have on the recommended information can be clearly indicated.

Moreover, according to an embodiment, a user can efficiently adjust a user's preference used for searching recommended information since a degree of influence on a user's preference of operation information is increased or decreased in response to the user's evaluation for the operation information.

According to this embodiment, operation information with more than or equal to a specified number of keywords included in the recommended information are extracted. Then a degree of similarity between search index for extracted operation information and that of recommended information are calculated. This decreases subjects for calculating a degree of similarity, and thereby reduces processing load.

Furthermore, according to an embodiment, operation information within a specified date and time is extracted and then a degree of similarity between a search index for extracted operation information and that for recommended information are calculated. This decreases subjects for calculating a degree of similarity, and thereby reduces processing load.

Still further, according to this embodiment, operation information that satisfies a specified operation pattern is extracted, and then a degree of similarity between a search index for extracted operation information and that for recommended information is calculated. This decreases subjects for calculating a degree of similarity, and thereby reduces processing load.

Moreover, according to an embodiment, keyword(s) included in recommendation information and element values of the keywords, and keywords included in recommendation reasons and the element value of the keywords are extracted. Among the extracted keywords, the element value for the same keyword are added and keywords with the added value is more than or equal to a specified value are extracted as keywords of recommendation reasons. Thus keywords that influence on recommendation reasons can be extracted. A user can find a degree of influence the keyword has on recommendation reasons by referring to results of multiplication of keyword values.

According to an embodiment, contents of recommendation reasons are compared and overlapped information is removed, thereby displaying the same recommendation reason can be prevented. This allows displaying various recommendation reasons where only the limited number of recommendation reasons can be displayed.

According to this disclosure, a vector of search index for recommendation information and a vector of search index for operation information are generated, and then an inner product between the generated vectors is calculated as the degree of similarity. Therefore the degree of similarity can be calculated properly.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information recommendation apparatus displaying recommendation information based on a user's preference generated from search indices for operation information with respect to operations previously performed by the user, comprising:
a degree of similarity calculation unit calculating a degree of similarity between the recommendation information and the operation information with respect to one of the operations based on a search index for said recommendation information and a search index for said operation information; and
an output unit outputting operation information having a degree of similarity calculated by said degree of similarity calculation unit that satisfies a specified condition as a recommendation reason for said recommendation information.

2. The information recommendation apparatus according to claim 1, comprising:
a feedback unit increasing or decreasing a degree of influence on said user's preference based on an input of the user for increasing or decreasing evaluation of the operation information output as the recommendation reason for said recommendation information by said output unit.

3. The information recommendation apparatus according to claim 1, wherein said degree of similarity calculation unit extracts operation information that includes more than or equal to a specified number of keywords included in said recommendation information, and calculates a degree of similarity between a search index for extracted operation information and the search index for said recommendation information.

4. The information recommendation apparatus according to claim 1, wherein said degree of similarity calculation unit extracts operation information within a specified date and time from said operation information, and calculates a degree of similarity between a search index for extracted operation information and the search index for said recommendation information.

5. The information recommendation apparatus according to claim 1, wherein said degree of similarity calculation unit extracts operation information that satisfies a specified operation pattern from said operation information, and calculates a degree of similarity between a search index for extracted operation information and the search index for said recommendation information.

6. The information recommendation apparatus according to claim 1, comprising:
a keyword extraction unit extracting keywords included in said recommendation information and element values of the keywords, and keywords included in said recommendation reason and corresponding element values, and among the extracted keywords, adding element values for the same keywords and extracting keywords with an added value of more than or equal to a specified value as keywords of said recommendation reason.

7. The information recommendation apparatus according to claim 1, comprising:
an overlapped information removal unit comparing contents of each recommendation reason and removing overlapped information.

8. The information recommendation apparatus according to claim 1, wherein said degree of similarity calculation unit generates a vector of search index for said recommendation information and a vector of search index for said operation information, and calculates an inner product between the generated vectors as said degree of similarity.

9. An information recommendation method that displays recommendation information based on a user's preference generated from search indices for operation information with respect to operations previously performed by the user, comprising;
storing a search index for said recommendation information and a search index for said operation information with respect to one of the operations;
calculating a degree of similarity between the recommendation information and the operation information based on a search index for said recommendation information and a search index for said operation information; and
outputting operation information having a degree of similarity calculated that satisfies a specified condition as a recommendation reason for said recommendation information.

10. The information recommendation method according to claim 9, comprising:
providing a feedback of increasing and decreasing a degree of influence on said user's preference based on an input of the user for increasing and decreasing evaluation of the operation information output as the recommendation reason for said recommendation information at said outputting.

11. The information recommendation method according to claim 9, wherein said calculating degree of similarity comprises:
extracting operation information that includes more than or equal to a specified number of keywords included in said recommendation information from said operation information; and
calculating a degree of similarity between a search index for the extracted operation information and the search index for said recommendation information.

12. The information recommendation method according to claim 9, wherein said calculating degree of similarity comprises:
extracting operation information within a specified date and time from said operation information; and
calculating a degree of similarity between a search index for extracted operation information and the search index for said recommendation information.

13. The information recommendation method according to claim 9, wherein said calculating degree of similarity comprises:
extracting operation information that satisfies a specified operation pattern from said operation information; and
calculating a degree of similarity between a search index for the extracted operation information and the search index for said recommendation information.

14. The information recommendation method according to claim 9, comprising:
extracting keywords included in said recommendation information and element values of the keywords, and keywords included in said recommendation reason and corresponding element values, and among the extracted keywords, adding element values for the same keywords and extracting keywords with an added value of more than or equal to a specified value as keywords of said recommendation reason.

15. The information recommendation method according to claim 9, comprising:
comparing contents of each recommendation reason and removing overlapped information.

16. The information recommendation method according to claim 9, wherein said calculating degree of similarity comprises:
generating a vector of search index for said recommendation information and a vector of search index for said operation information, and calculating an inner product between the generated vectors as the degree of similarity.

17. A computer-readable storage medium storing an information recommendation program causing a computer to execute processes, comprising:
calculating a degree of similarity between recommendation information and operation information based on a search index for operation information with respect to an operation previously performed by a user and a search index for recommendation information;
outputting operation information having a degree of similarity that satisfies a specified condition as a recommendation reason for said recommendation information.

18. The computer-readable storage medium according to claim 17, causing a computer to execute processes of:
providing a feedback of increasing and decreasing a degree of influence on said user's preference based on an input of the user for increasing and decreasing evaluation of the operation information output as recommendation reason for said recommendation information at said outputting.

19. The computer-readable storage medium according to claim 17, wherein calculating said degree of similarity comprises:
extracting operation information that includes more than or equal to a specified number of keywords included in said recommendation information from said operation information; and
calculating a degree of similarity between a search index for the extracted operation information and the search index for said recommendation information.

20. The computer-readable storage medium according to claim 17, wherein calculating said degree of similarity comprises:
extracting operation information within a specified date and time from said operation information; and
calculating a degree of similarity between a search index for the extracted operation information and the search index for said recommendation information.
